(19) United States
(12) Patent Application Publication
(10) Pub. No.: US 2020/0265537 A1
(43) Pub. Date: Aug. 20, 2020

(54) System and Method of Managing and Scheduling Childcare Services

(71) Applicant: Jean Baptiste Mbaya, Decatur, GA (US)

(72) Inventor: Jean Baptiste Mbaya, Decatur, GA (US)

(21) Appl. No.: 16/792,185

(22) Filed: Feb. 14, 2020

Related U.S. Application Data
(60) Provisional application No. 62/805,833, filed on Feb. 14, 2019.

(51) Int. Cl. G06Q 50/22; G06Q 10/10; G06Q 30/02; G06Q 30/06; G06F 16/23

(52) U.S. Cl. CPC G06Q 50/22; G06Q 10/1095; G06Q 30/0282; G06F 16/2379; G06Q 30/0205; G06Q 30/0605; G06Q 30/0206

(57) ABSTRACT

A method of managing and scheduling childcare services is implemented by a computer network that allows a user (i.e. a client) to typically find childcare service (e.g. babysitting) amongst other geospatially local users (i.e. providers). The client generates a session request for a childcare service through the computer network, which identifies the best available providers to take on the childcare service. Once an arbitrary best available provider accepts the session request through the computer network, the client is then prompted to confirm the session request with the arbitrary best available provider. An administrative process for the session request between the client and the arbitrary best available provider is then executed through the computer network so that the arbitrary best available provider is able to take on the childcare service for the client and is financially compensated by the client.

The current application claims a priority to the U.S. Provisional Patent application Ser. No. 62/805,833 filed on Feb. 14, 2019.

### FIELD OF THE INVENTION

The present invention generally relates to systems and methods for matching customers with service providers. More specifically, the present invention relates to systems and methods for connecting customers with childcare service providers.

### BACKGROUND OF THE INVENTION

An objective of the present invention is to provide parents and guardians, preferably referred to as customers, the convenience to request babysitting and/or other child care services from contractors and/or employees, preferably referred to as employees, through a software application at a much more affordable rate. In the preferred embodiment of the present invention, the system of the present invention comprises two types of user accounts: customers and employees. At sign up, the users are provided with a plurality of choices to sign up as a customer or an employee. Further, the users can sign up in multiple accounts to request and/or provide childcare services. After signing up and providing all the necessary information, a customer can start requesting childcare services for future or immediate needs. In the preferred embodiment of the present invention, all available employees currently logged in and available get a request notification. The system of the present invention maintains the service request active for a certain amount of time. If no employee accepts the service request, the service request expires and the customer can choose to either try again, abandon the request, or try again later. The service request can require a plurality of information including, but not limited to, number of children, number of hours, date, and time. The software application of the present invention will provide a plurality of User Interfaces (UIs) where the users can input information. Further, customers can choose to have the service request fulfilled at the customer's location or an outside location. In addition, the software application of the present invention will provide customers with the estimated hourly rate preferably based on area and additional plurality of factors including, but not limited to, standard of living, interest rates, consumer index, time of the day, etc.

In the preferred embodiment of the present invention, the system of the present invention accepts a plurality of payment methods such as credit cards or government-issued childcare benefits cards. Furthermore, the system of the present invention enables employees to transfer accepted scheduled tasks to other employees in case the employees will not be able to keep up a schedule due to unforeseeable circumstances. In the preferred embodiment of the present invention, employees register and get verified through government-issued identification (IDs) before being issued access to the system of the present invention. Further, the employees will go through regular background checks, mental and psychological assessment, etc.

### BRIEF DESCRIPTION OF THE DRAWINGS

FIG. 1 is a block diagram illustrating the system of the present invention.

FIG. 2 is a flowchart illustrating an overall process for the method of the present invention.

FIG. 3 is a continuation of the FIG. 2.

FIG. 4 is a flowchart illustrating a subprocess of entering details of a session request.

FIG. 5 is a flowchart illustrating a subprocess of creating a new child profile.

FIG. 6 is a flowchart illustrating a subprocess of selecting a provider account based on proximity to a client account.

FIG. 7 is a flowchart illustrating a subprocess of further selecting a provider account based on a favorability rating of the provider account.

FIG. 8 is a flowchart illustrating a subprocess of notifying a provider account of a session request.

FIG. 9 is a flowchart illustrating a subprocess of resubmitting a session request.

FIG. 10 is a flowchart illustrating a subprocess of determining a session price to be paid by a client account to a provider account

FIG. 11 is a flowchart illustrating a subprocess of notifying a client account of a change of location by a provider account.

FIG. 12 is a flowchart illustrating a subprocess of selecting a different provider account.

FIG. 13 is a flowchart illustrating a process of collecting transactional data through multiple iterations of the overall process.

FIG. 14 is a flowchart for the present invention illustrating the system of the present invention.

FIG. 15 is a flowchart for the present invention illustrating the registration process of the present invention.

FIG. 16 is a flowchart for the present invention illustrating the plurality of user information in a user profile of the present invention.

FIG. 17 is a flowchart for the present invention illustrating the plurality of variables in a service request of the present invention.

FIG. 18 is a flowchart for the present invention illustrating the plurality of variables in a session of the present invention.

FIG. 19 is a flowchart for the present invention illustrating the plurality of variables in child profile of the present invention.

FIG. 20 is a flowchart for the present invention illustrating the plurality of variables in the pricing method of the present invention.

FIG. 21 is an illustration of the present invention showing a splash screen of the software application of the present invention.

FIG. 22 is an illustration of the present invention showing a profile screen of the software application of the present invention.

FIG. 23 is an illustration of the present invention showing a first main screen of the software application of the present invention.

FIG. 24 is an illustration of the present invention showing a second main screen of the software application of the present invention.

FIG. 25 is an illustration of the present invention showing a third main screen of the software application of the present invention.

FIG. 26 is an illustration of the present invention showing a pending screen of the software application of the present invention.

FIG. 27 is a flowchart for the present invention illustrating the service request method of the present invention.

FIG. 28 is a flowchart for the present invention illustrating the request offering method of the present invention.

FIG. 29 is a flowchart for the present invention illustrating the service accepting method of the present invention.

### DETAILED DESCRIPTION OF THE INVENTION

All illustrations of the drawings are for the purpose of describing selected versions of the present invention and are not intended to limit the scope of the present invention.

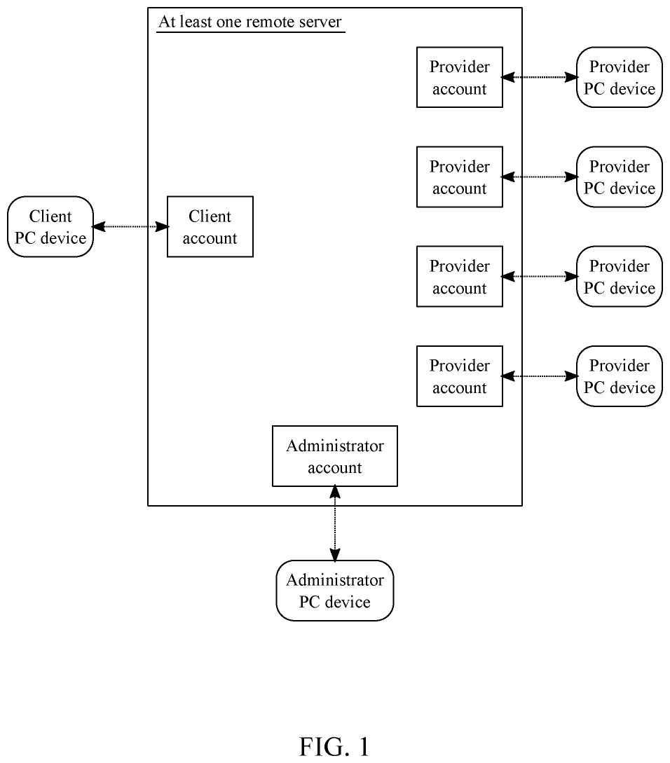

The present invention is a system and method of managing and scheduling childcare services that allows users to typically find childcare service (e.g. babysitting) amongst other local participants of the present invention. As can be seen in FIG. 1, the system of the present invention is provided with at least one client account managed by at least one remote server (Step A). A client account allows a user to interact with the present invention in order to find childcare services for their child or children. The remote server acts as a communication hub to exchange commands and information amongst different users of the present invention. Moreover, the at least one client account is associated with the client personal computing (PC) device, which allows the user of a client account to interface with the present invention. The client PC device can be, but is not limited to, a desktop, a laptop, a tablet computer, or a computerized mobile phone. The system of the present invention is also provided with a plurality of provider accounts managed by the remote server (Step B). A provider account allows a user to interact with the present invention in order to provide childcare services for someone else's child or children. Each provider account includes a provider profile that is verified personal information describing the user of a provider account. This verified personal information allows anyone to feel safe and comfortable while using childcare services provided by the user of a provider account. In addition, each provider account is associated with a corresponding provider PC device, which allows the user of a provider account to interface with the present invention. Similar to the client PC device, the corresponding provider PC device can be, but is not limited to, a desktop, a laptop, a table computer, or a computerized mobile phone.

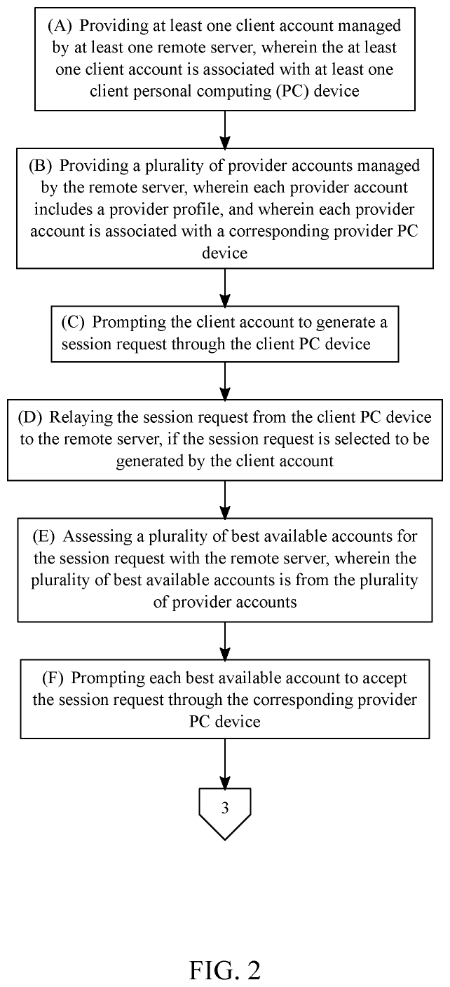

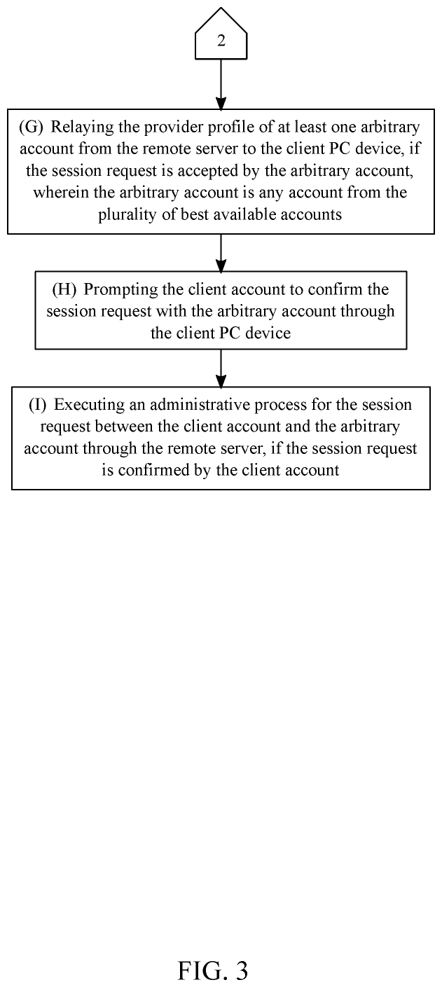

As can be seen in FIGS. 2 and 3, the overall process for the method of the present invention allows to efficiently and effectively coordinate childcare services amongst a lot of different users. The overall process begins by prompting the client account to generate a session request through the client PC device (Step C). The session request is a specific childcare service being requested by the client account and includes the details that are required to complete the specific childcare service. The overall process continues by relaying the session request from the client PC device to the remote server (Step D), if the session request is selected to be generated by the client account, which allows the session request to be processed by the remote server. The overall process proceeds by assessing a plurality of best available accounts for the session request with the remote server (Step E), wherein the plurality of best available accounts is from the plurality of provider accounts. The users of the best available accounts are determined by the remote server to best be able to complete the specific childcare service and to accommodate for its situational conditions. The overall process continues by prompting each best available account to accept the session request through the corresponding provider PC device (Step F) so that the user of each best available account is presented with the opportunity to complete the specific childcare service. The overall process proceeds by relaying the provider profile of at least one arbitrary account from the remote server to the client PC device (Step G), if the session request is accepted by the arbitrary account, which allows the user of the client account to see the verified personal information disclosed in the provider profile of the arbitrary account and allows the user of the client account to feel more safe and comfortable about the user of the arbitrary account performing the specific childcare service. Moreover, the arbitrary account is defined as any account from the plurality of best available accounts. The overall process continues by prompting the client account to confirm the session request with the arbitrary account through the client PC device (Step H) so that the users of the client account and the arbitrary account are both able to agree to the specific childcare service. The overall process concludes by executing an administrative process for the session request between the client account and the arbitrary account through the remote server (Step I), if the session request is confirmed by the client account. The administrative process allows the present invention to manage the administrative responsibilities between the users of the client account and the arbitrary account, such as the financial transaction, the scheduling notifications, the reminder notifications, etc.

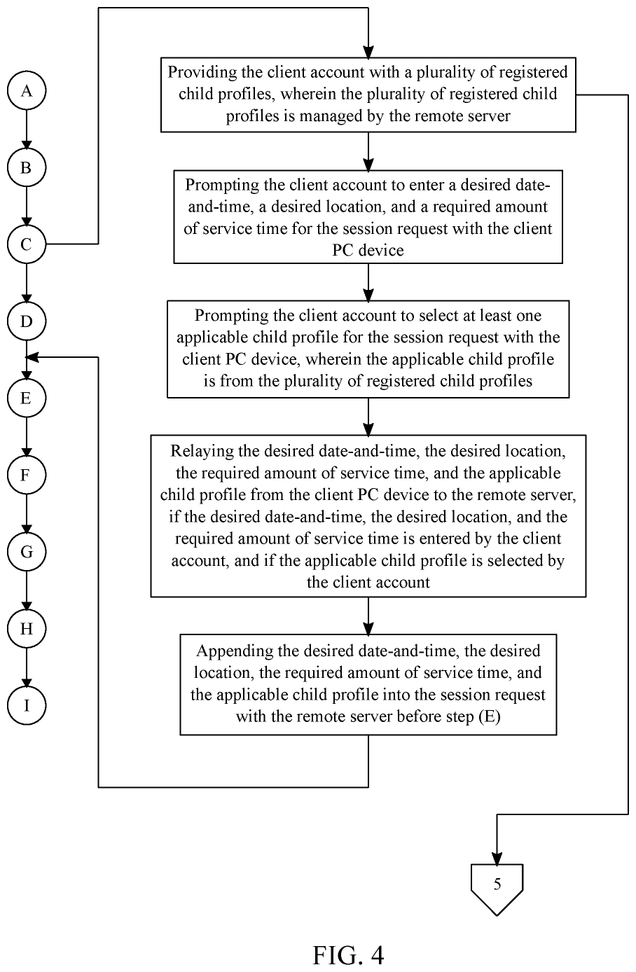

The present invention may include a subprocess to generate the details of the session request, which is shown in FIG. 4. Thus, the client account is provided with a plurality of registered child profiles, wherein the plurality of registered child profiles is managed by the remote server. Each registered child profile is the personal information describing a child of the user of the client account. This subprocess begins by prompting the client account to enter a desired date-and-time, a desired location, and a required amount of service time for the session request with the client PC device. For example, the desired date-and-time, the desired location, and the required amount of service time would allow the user of a provider account to know when, where, and how long to babysit a child of the user of the client account. This subprocess continues by prompting the client account to select at least one applicable child profile for the session request with the client PC device, wherein the applicable child profile is from the plurality of registered child profiles. The applicable child profile relates to which and how many of the children of the user of the client account requires the specific childcare service. Moreover, if the desired date-and-time, the desired location, and the required amount of service time is entered by the client account, and if the applicable child profile is selected by the client account, the client PC device then relays the desired date-and-time, the desired location, the required amount of service time, and the applicable child profile to the remote server so that the remote server is able to append the desired date-and-time, the desired location, the required amount of service time, and the applicable child profile into the session request before Step E. This allows these different pieces of data to be used for the session request in other portions of the method of the present invention as well as fully describes the nature of the session request.

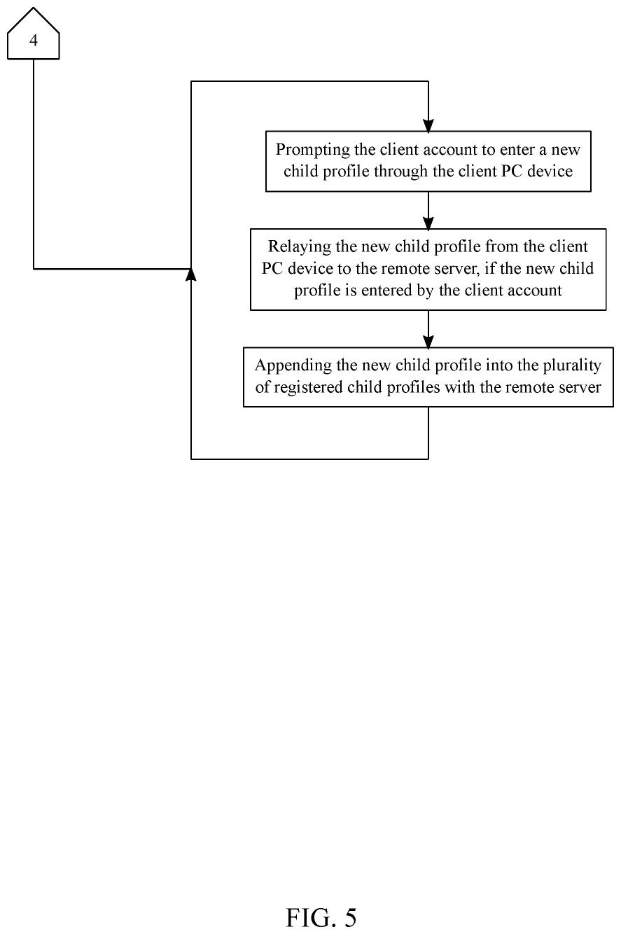

In addition, the user of a client account may use to the present invention to keep track of and/or record new children, which is shown in FIG. 5. Thus, the client PC device prompts the client account to enter a new child profile. The new child profile could be used for a newborn baby or a newly-adopted child. If the new child profile is entered by the client account, the client PC device then relays the new child profile to the remote server so that the remote server is able to append the new child profile into the plurality of registered child profiles. In the future, this allows the user of the client account to select the new child profile as the applicable child profile.

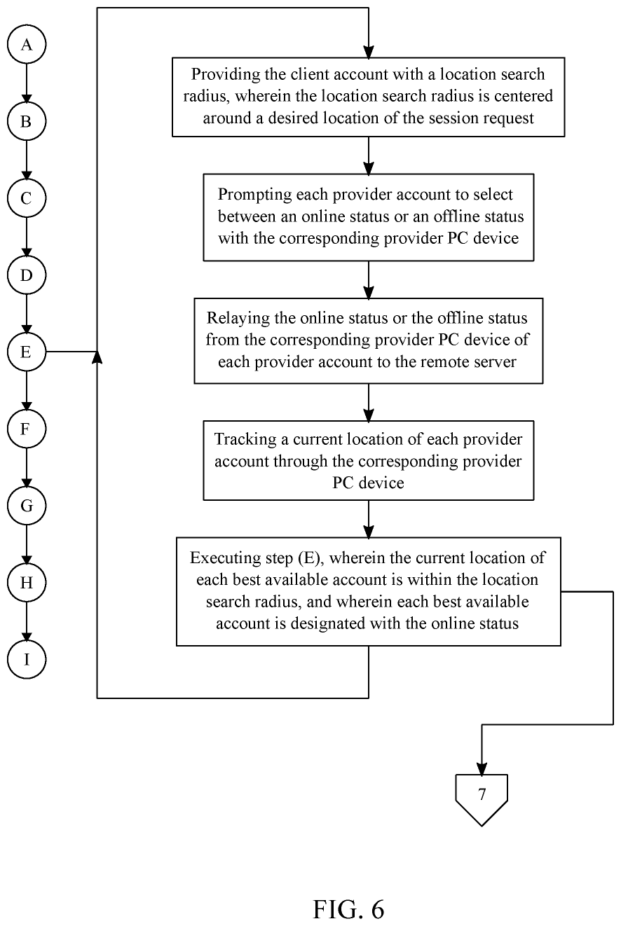

As can be seen in FIG. 6, the present invention may further include a subprocess to assess the best available accounts from the plurality of provider accounts. Thus, the client account is provided with a location search radius, which is centered around the desired location of the session request. The location search radius allows the user of a client account to select the user of a provider account that is nearby for the specific childcare service. The location search radius can be manually inputted by the client account or can be automatically designated by the remote server. This subprocess begins by prompting each provider account to select between an online status or an offline status with the corresponding provider PC device. The online status means that the user of a provider account is willing to take on work for a childcare service, while the offline status means that the user of a provider account is not willing to take on work for a childcare service. Consequently, the user of a provider account is able to readily select between being available to review and accept/deny work and being unavailable to review and accept/deny any work. Moreover, the online status or the offline status from the corresponding provider PC device of each provider account is relayed to the remote server so that the remote server is able to manage the online status or the offline status of each provider account. The current location of each provider account is tracked through the corresponding provider PC account so that the remote server is able to know where the user of a provider account is in relation to the desired location of the session request. Thus, Step E is executed so that the current location of each best available account is within the location search radius and so that each best available account is designated with the online status, which allows the present invention to assess and identify the best available accounts for the session request.

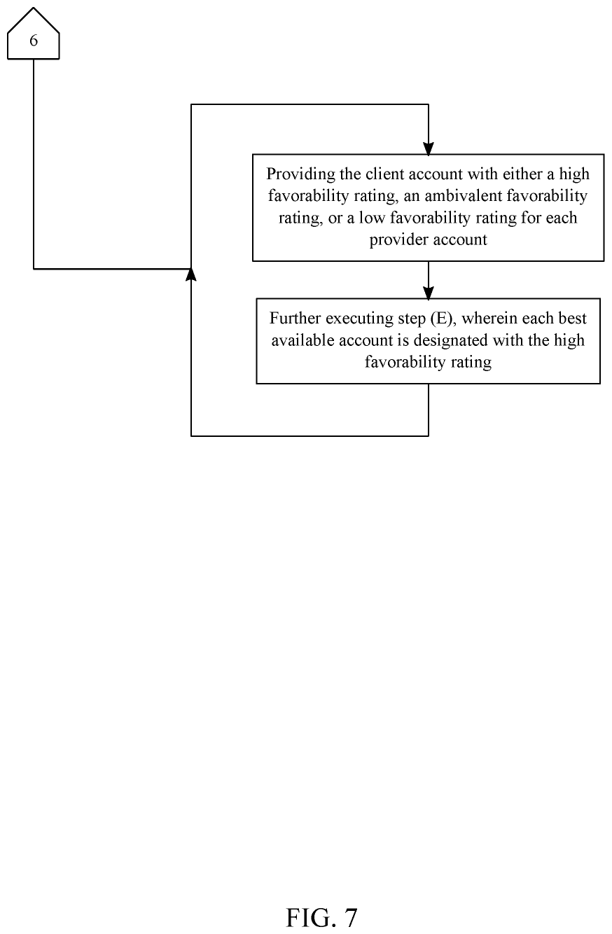

In addition, the user of a client account may use the present invention to keep track of a favorite user of a provider account as well as a disliked user of a provider account, which is shown in FIG. 7. Thus, the client account is provided with either a high favorability rating, an ambivalent favorability rating, or a low favorability rating for each provider account. Each provider account is defaulted to the ambivalent favorability rating, while the high favorability rating or the low favorability rating is then selected by the client account. These favorability ratings can also be used to optimize the selection of the best available accounts for the session request. Thus, Step E is further executed so that each best available account is designated with the high favorability rating. In addition, a provider account designated with the ambivalent favorability may sometimes be selected as one of the best available accounts for the session request, if the client account broadens the search for the best available accounts. A provider account designated with a low favorability rating would almost never be selected as one of the best available accounts for the session request.

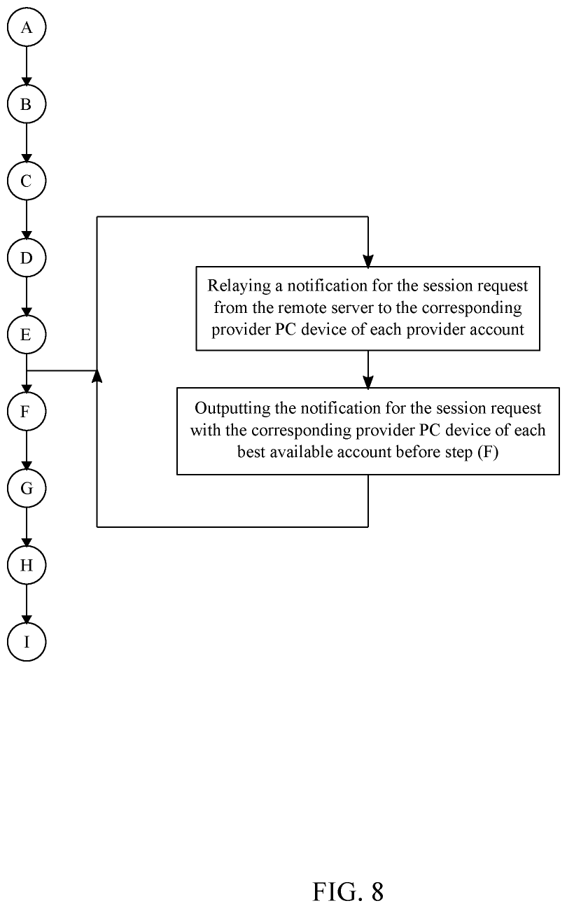

As can be seen in FIG. 8, the present invention may further include a subprocess to constantly notify the user of a provider account of the currently available work relating to a childcare service. This subprocess begins by relaying a notification for the session request from the remote server to the corresponding provider PC device of each best available account so that the user of a provider account is notified in real-time of the session request. The notification of the session request is then outputted by the corresponding provider PC device of each best available account before step F in order to make sure that the user of each best available account is fully aware of the session request. The notification of the session request can be visually outputted by a provider PC device, audibly outputted by a provider PC device, or outputted as a combination thereof.

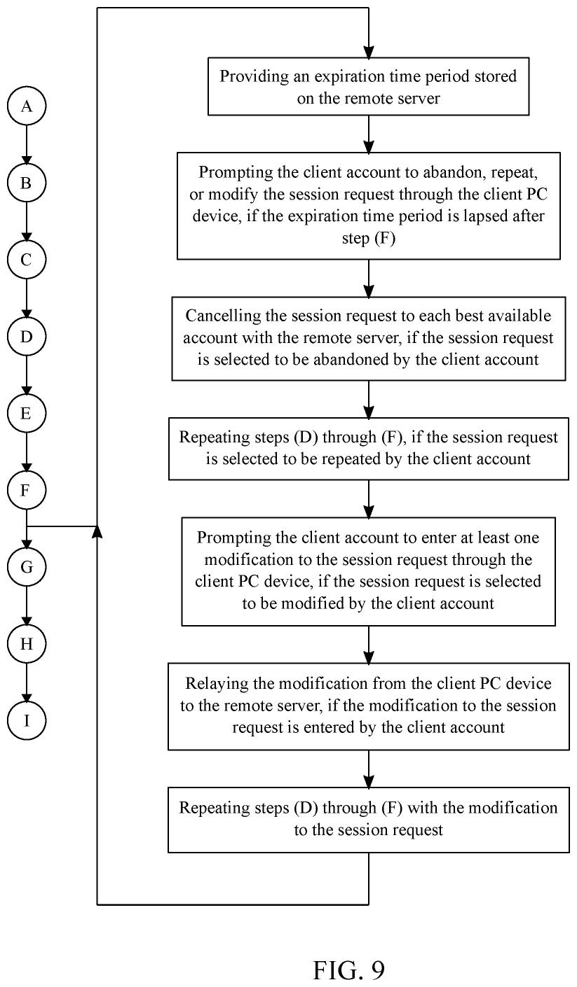

The present invention may further include a subprocess to systematically approach a session request that has trouble being accepted by the user of a provider account, which is shown in FIG. 9. Thus, the present invention provides an expiration time period that is stored on the remote server. The expiration time period is the amount of the time that needs to lapse before the present invention reconsiders what to do with the session request. This subprocess consequently begins by prompting the client account to abandon, repeat, or modify the session request through the client PC device, if the expiration time period is lapsed after Step F. If the session request is selected to be abandoned by the client account, the remote server then cancels the session request to each best available account. This allows the client account to try the session request at some later time during a different iteration of the overall process. If the session request is selected to be repeated by the client account, Step D through Step F are repeated in order to again try to find a user of a provider account willing to accept the session request with the exact same details and situational conditions. If the session request is selected to be modified by the client account, the client PC device then prompts the client account to enter at least one modification to the session request. The modification is some changes to the details and/or the situational conditions of the session request in order to make the session request to be more desirable for a user of a provider account. Once the modification to the session request is entered by the client account, the modification is then relayed from the client PC device to the remote server so that the remote server is able to apply the modification to the server account. Thereafter, Step D through Step F are repeated with the modification to the session request in order to again try to find a user of a provider account willing to accept the session request with some changes to its details and/or its situational conditions.

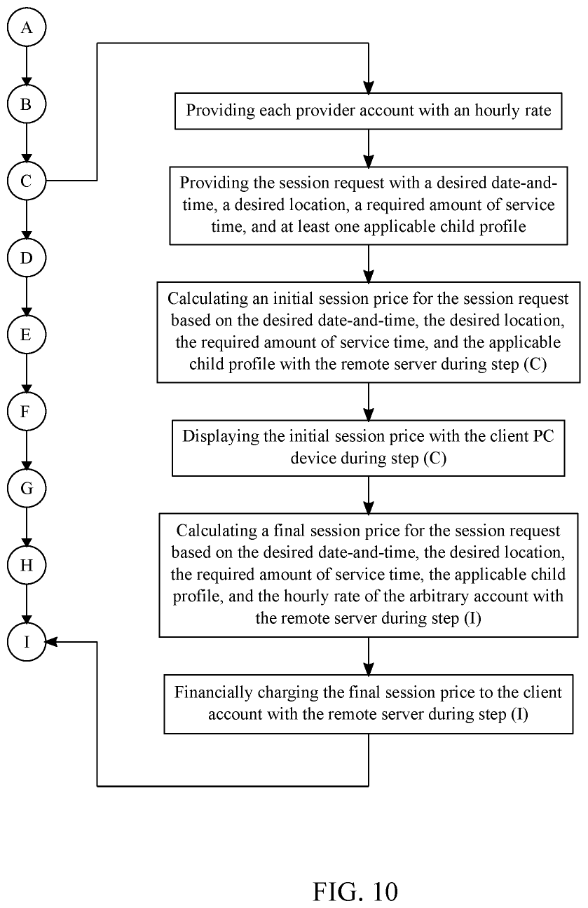

As can be seen in FIG. 10, the present invention may further include a subprocess that allows the client account to financially compensate the arbitrary account for completion of the session request. Thus, the present invention provides each provider account with an hourly rate in order to determine their financial compensation. The subprocess begins by calculating an initial session price for the session request based on the desired date-and-time, the desired location, the required amount of service time, and the applicable child profile with the remote server during Step C so that the client account is able to preview a final session price by calculating the initial session price. Consequently, the initial session price is not dependent on the hourly rate of a provider account because no provider account has accepted the session request yet during Step C. This subprocess continues by displaying the initial session price with the client PC device during Step C so that the user of a client account is able to view the initial session price and decide on whether or not to submit the session request. Thereafter, this subprocess proceeds by calculating the final session price for the session request based on the desired date-and-time, the desired location, the required amount of service time, the applicable child profile, and the hourly rate of the arbitrary account with the remote server during Step I. This allows the remote server to financially charge the final session price to the client account during Step I as a part of the administrative process.

The calculation of the initial session price and the final session price is based on a variety of price control factors. One such price control factor may be the number of children associated with the session request. Thus, the initial session price is proportionally based on a number of children indicated by the applicable child profile. In addition, the final session price is proportionally based on the number of children indicated by the applicable child profile.

Another such price control factor may be a plurality of time ranges that are stored by the remote server, wherein each time range is designated with a busyness rating. For example, the time range of the morning to the afternoon would have a low busyness rating because children are typically at school, while the time range of the evening would have a high busyness rating because children are typically at home. Thus, the desired date-and-time is within a specific range from the plurality of time ranges so that the initial session price is proportionally based on the busyness rating of the specific range and similarly so that the final session price is proportionally based on the busyness rating of the specific range.

Another such price control factor may be an in-house setting and an outside setting that are stored by the remote server. The in-house setting means that the session request is taking place within the home of the user of a client account, and the outside setting means that the session request is taking place somewhere away from the home of the user of a client account. Thus, the initial session price is higher, if the desired location is designated as the in-house setting instead of the outside setting. Likewise, the final session price is higher, if the desired location is designated as the in-house setting instead of the outside setting.

Another such price control factor may be a plurality of economically-defined regions that are stored by the remote server, wherein each economically-defined region is designated with an affluency rating. For example, an economically-defined region with a higher affluency rating would be the suburbs, while an economically-defined region with a lower affluency rating would be the slums. Thus, the desired location of the session request is within a specific region from the plurality of economically-defined regions so that the initial session price is proportionally based on the affluency rating of the specific region and similarly so that the final session price is proportionally based on the affluency rating of the specific region.

Another such price control factor may be a young-child age threshold because younger children are more difficult to watch over. For example, the young-child age threshold is less than 4 years old. The young-child age threshold is also stored on the remote server. Thus, the hourly rate is higher, if an age indicated in the applicable child profile is lower than the young-child age threshold. Conversely, the hourly rate is lower, if the age indicated in the applicable child profile is higher than the young-child age threshold.

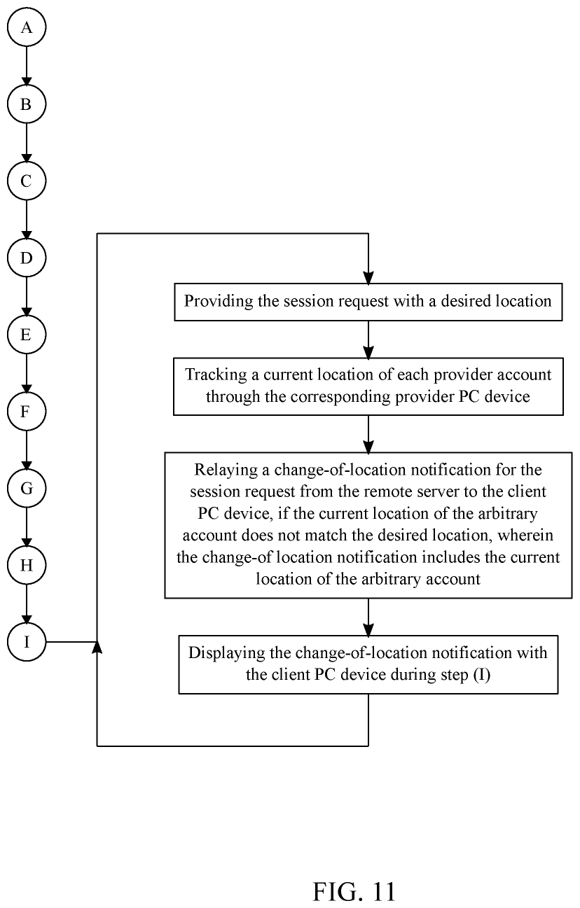

The present invention may further include a subprocess that allows the user of a client account to track the whereabouts of the user of a provider account, which is shown in FIG. 11. This subprocess begins by tracking a current location of each provider account through the corresponding provider PC device, which preferably done with a global positioning system (GPS) module implemented on the corresponding provider PC device. If the current location of the arbitrary account does not match the desired location of the session request, the remote server then relays a change-of-location notification for the session request to the client PC device. The change-of location notification includes the current location of the arbitrary account so that the user of the client account is able to know the new location of the user of the arbitrary account as well as their child or children. Moreover, the client PC device displays the change-of-location notification during Step I as part of the administrative process, which should prevent the user of the arbitrary account from taking the child of the user of the client account to unknown and/or unwanted locations.

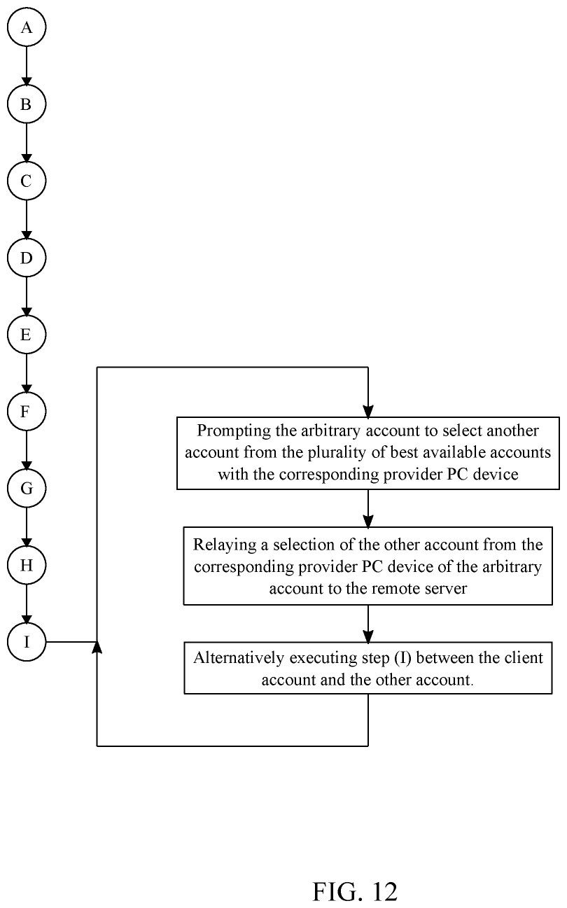

As can be seen in FIG. 12, the present invention may further include a subprocess that allows the user of the arbitrary account to transfer the session request to the user of another provider account. This subprocess would be executed if the user of the arbitrary account is unable to keep their commitment to complete the session request. This subprocess begins by prompting the arbitrary account to select another account from the plurality of best available accounts with the corresponding provider PC device so that the user of the client account does not have a large drop off in quality of service while transferring from the arbitrary account to the other account if the other account is from the plurality of best available accounts. The selection of the other account is then relayed from the corresponding provider PC device of the arbitrary account to the remote server so that Step I is alternatively executed between the client account and the other account instead of the arbitrary account.

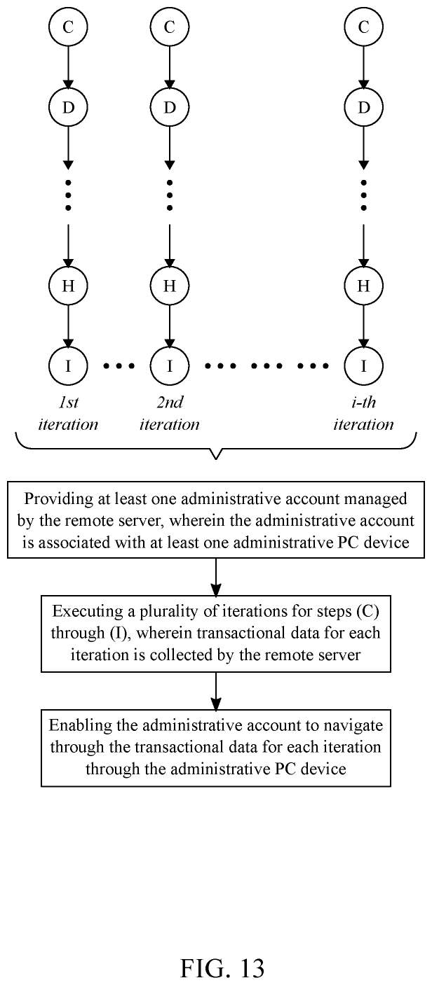

As can be seen in FIG. 13, the present invention may further include a subprocess that allows an administrator to manage the interactions between the client account and the plurality of provider accounts. Thus, the present invention is provided with at least one administrative account managed by the remote server, wherein the administrative account is associated with at least one administrative PC device. An administrator account allows a user to overlook the interactions and the transactions that are occurring between the user of the client account and the users of the provider accounts. The administrative PC device can be, but is not limited to, a desktop, a laptop, a tablet computer, or a computerized mobile phone. This subprocess takes full effect once a plurality of iterations for Step C through Step I is executed over a period of time so that transactional data for each iteration is collected by the remote server. The transactional data for each iteration includes, but is not limited to, the final session price and the number of completed session requests by each provider account. This subprocess concludes by enabling the administrative account to navigate through the transactional data for each iteration through the administrative PC device because the user of the administrative account is in some sort of managerial capacity and needs to identify financial trends amongst the actions by the plurality of provider accounts.

### Supplemental Description

The present invention provides systems and methods for providing babysitting services. In the preferred embodiment of the present invention, the system of the present invention provides a software application preferably referred to as liTTLE bUNNY. The software application of the present invention allows employees to input the employees' addresses and/or locations, as well as to be located when employees indicate an active status. Furthermore, the software application of the present invention allows customers to submit a service request and enables employees nearby to see the request and accept or ignore the service request. In the preferred embodiment of the present invention, the software application of the present invention can be provided to operate in various computing devices, such as smartphone or computers. Furthermore, the software application of the present invention can be provided to operate on or along with third-party services, such as search engines or web browsers. In an embodiment of the present invention, the software application of the present invention can be managed by an administrative platform where administrative staff can monitor, direct and manage different aspects of the software application including, but not limited to, history, currently available employees, list of name of employees who are currently busy, the number of children, the number of hours completed, number of hours left, and individual revenue for the day, week, moth and year, etc. In alternate embodiments of the present invention, the software application of the present invention can comprise different system architectures designed to operate in alternate systems or computing devices.

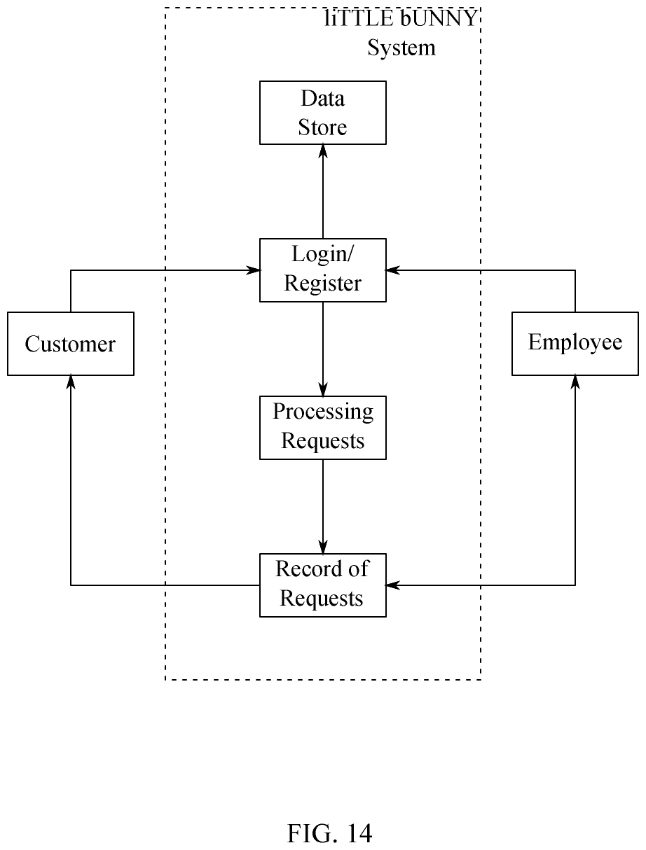

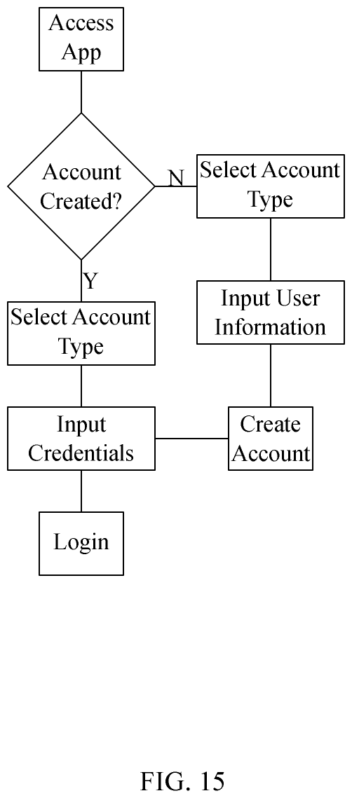

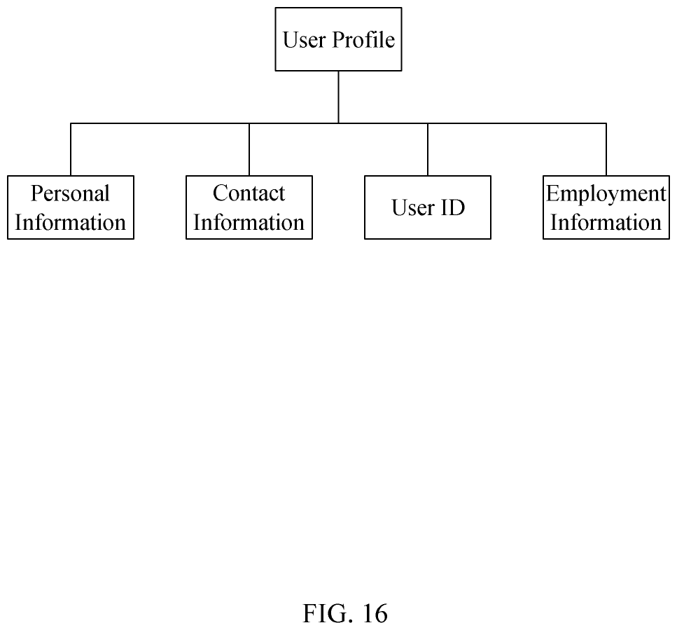

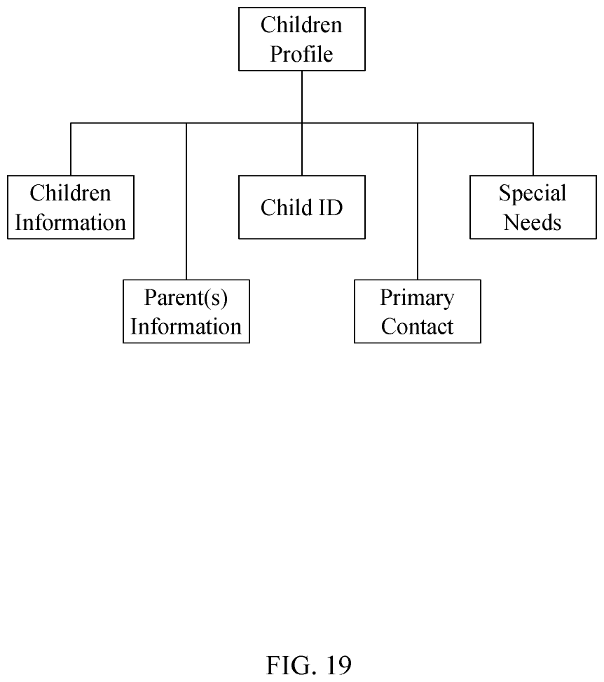

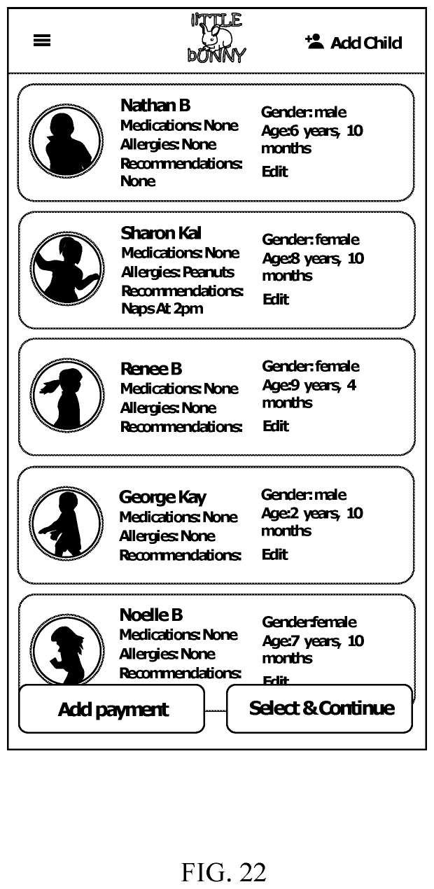

In the preferred embodiment of the present invention, the system of the present invention enables users to register and create a profile. As can be seen in FIGS. 14 and 15, the system of the present invention enables users to register and create one or more profiles as a customer or employee, or both. As can be seen in FIGS. 13, 15, 21, and 22, users can register and create a profile through the software application of the present invention. Further, the software application of the present invention can enable users to input a plurality of data through various methods, such as manually inputting data, submitting media, voice input, etc. In addition, the system of the present invention utilizes machine-learning algorithms and Artificial Intelligence (AI) to assist users in completing various tasks and requests on the software application of the present invention. In an embodiment of the present invention, the machine-learning algorithms can classify customers based on behavior and automatically match the customers to employees of the same or different classification depending on different variables. AI can further be utilized to assist customers by verbally helping customers with step by step instructions and answering questions. The main goal of both AI and machine-learning algorithms is to promote user satisfaction of the present invention. In the preferred embodiment of the present invention, the software application of the present invention enables users to input a plurality of data according to the user profile. As can be seen in FIG. 16, the users' one or more profiles can include a plurality of user information including, but not limited to, personal information such as name, date of birth, contact information, employment information, etc. Further, the software application of the present invention enables customers to input child information to create a child profile. As can be seen in FIGS. 19 and 22, customers can input a plurality of child information including, but not limited to, child's name, age, parents information, date of birth, primary contact information, and any special needs information. Furthermore, the system of the present invention assigns an identification to the users according to the profile, such as customer ID or child ID. Similarly, the system of the present invention enables users to create an employee profile by providing a plurality of user information as well as child information if the users also desire to request childcare services. In the preferred embodiment of the present invention, the employee registration process of the present invention further involves a verification and background check process to vet the users who desire to provide childcare services with the present invention. Further, the system of the present invention assigns an employee ID. In alternate embodiments of the present invention, the registration process and verification process of the present invention may comprise alternate methodology to meet various requirements of different jurisdictions.

In the preferred embodiment of the present invention, the system of the present invention enables users to submit one or more service requests. The main services offered through the software application of the present invention are childcare services which are provided by one or more employees. The system of the present invention can provide both on-demand and scheduled childcare services. On-demand childcare services include spontaneous and for-immediate-need services without the need to plan or request questions, while scheduled services are predetermined services with necessary information provided prior the childcare services are provided. Administrative users can intervene by calling or chatting with the customers, and customers can ask questions all before the scheduling is completed. In the preferred embodiment of the present invention, the scheduled childcare service requests are less expensive than on-demand service requests. Furthermore, the system of the present invention provides a planner feature linking customers to one or more employees for a period in the future such as week(s), month(s), or year(s). The customers can enter a schedule in the planner feature which will take care of requesting the booking of childcare services from the customers' favorite employees. The planner feature of the present invention can manage the relationship between customers and employees by finding available employees closest to the customers and saving the employees on the customers' waiting list, behind the scenes. The planner feature of the present invention shows customers the address where the customers are supposed to drop off the one or more children as days go by. In the preferred embodiment of the present invention, customers must book at least five days within at least one week to qualify for the planner feature. Further, customers utilizing the planner feature of the present invention get a different base price for one week and a different base price for a month, a trimester, a semester, and/or a year. In alternate embodiments of the present invention, the planner feature of the present invention may comprise different tools or rewards for customers to plan future childcare services.

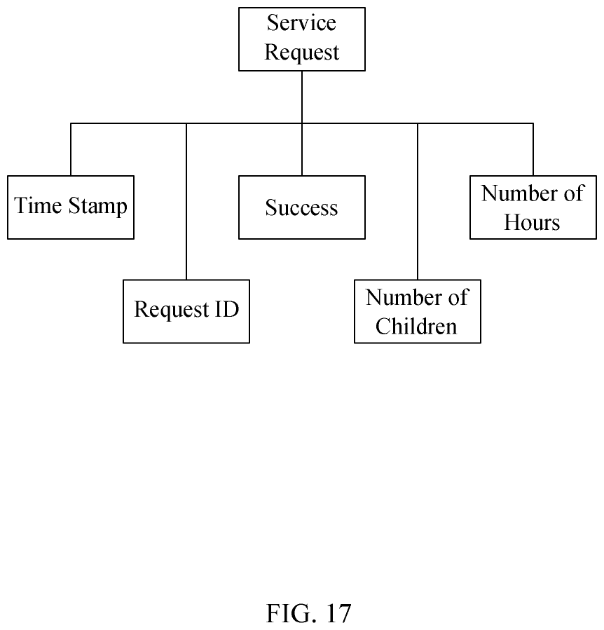

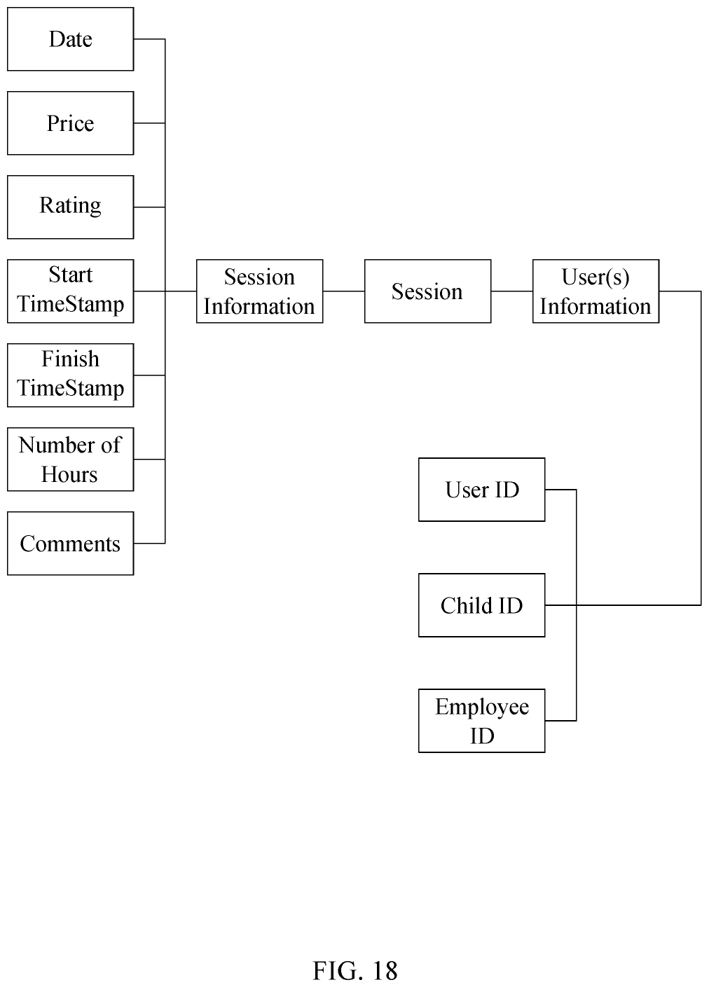

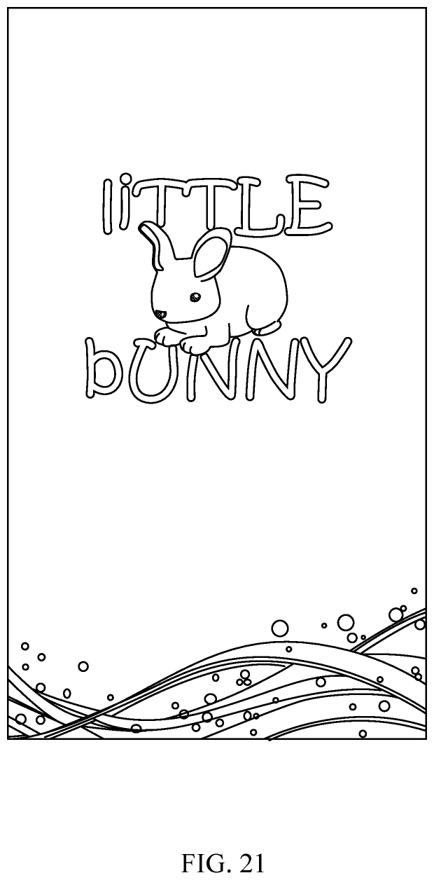

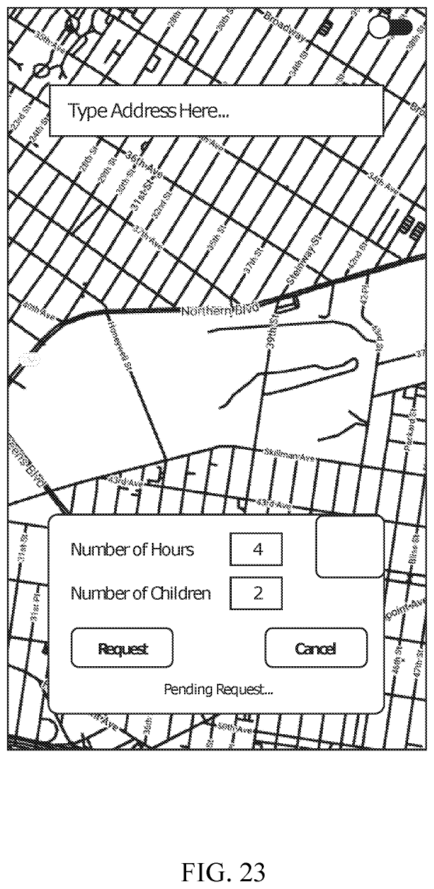

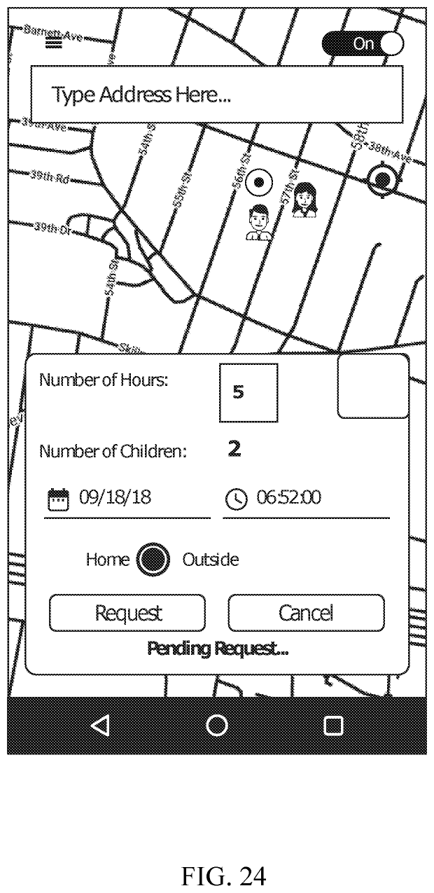

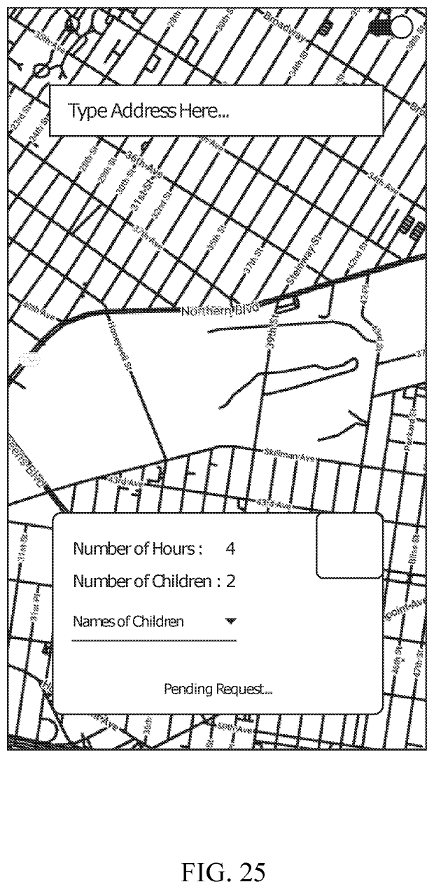

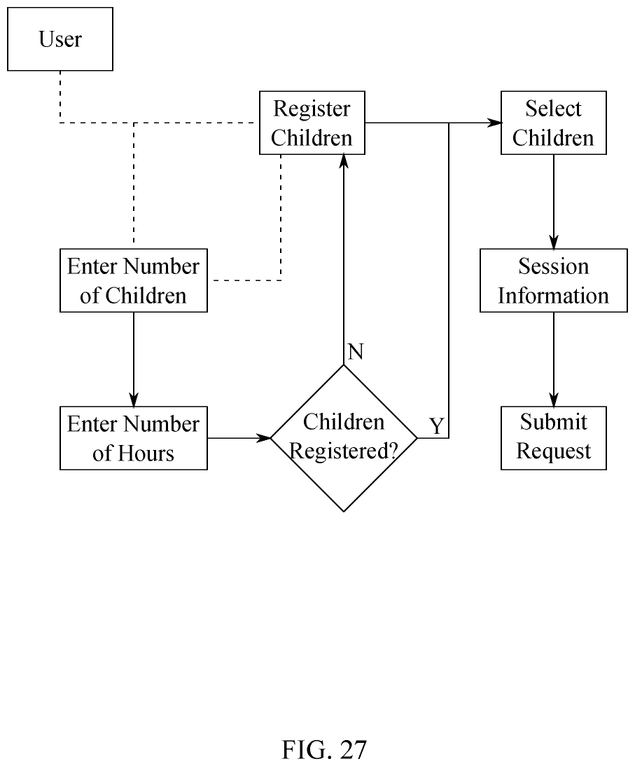

In the preferred embodiment of the present invention, the system of the present invention requests users to register one or more children involved in one or more service requests. As can be seen in FIGS. 21, 22, and 27, users are prompted to register one or more children, however users can skip the children registration during the registration process on the software application of the present invention. As can be seen in FIG. 27, users can start the service request process without registering one or more children. In the preferred embodiment of the present invention, the service request process of the present invention involves a plurality of variables. As can be seen in FIG. 17, the plurality of variables of a service request can include, but is not limited to, time stamp, service request ID, success value, number of children, number of hours, etc. Further, a service session can include a plurality of session information variables as well as user(s) information variables which are utilized to setup one or more service sessions. As can be seen in FIG. 18, the plurality of session information variables can include, but is not limited to, date, price, rating, start timestamp, finish timestamp, number of hours, or comments, and the plurality of user(s) information variables can include, but is not limited to, user ID, child ID, employee ID, etc. In alternate embodiments of the present invention, the plurality of variables and/or information involved in a service request and/or session can be modified to further accommodate different aspects for special childcare services. As can be seen in FIGS. 23-25, the software application of the present invention prompts users to input a plurality of information to submit one or more service requests. As can be seen in FIG. 27, if the one or more children are not already registered under the customer's account, the software application of the present invention prompts the customer to register the one or more children and enter some payment methods. As can be seen in FIG. 27, then the customer can continue the service request process by providing the number of hours the childcare service will last as well as the ages and genders of the one or more children. Furthermore, the system of the present invention enables customers to create a favorite list with a plurality of employees which the customers prefer. The system of the present invention enables users to submit a service request with the preferred plurality of employees, but if no favorite employee is available for the service request, the system of the present invention enables users to expand the service request search. Furthermore, both customers and employees will have a least-favorite list where, on the customer side, the least-favorite list of employees will contain the names of employees who will not view future service requests from the customers. On the employee side, the least-favorite list of customers contains the names of customers from whom the employee does not want to receive future requests. In the preferred embodiment of the present invention, all information apart from names and addresses of the customers is not visible to other customers or employees. In alternate embodiments of the present invention, the software application of the present invention may comprise alternate methods to submit one or more service requests.

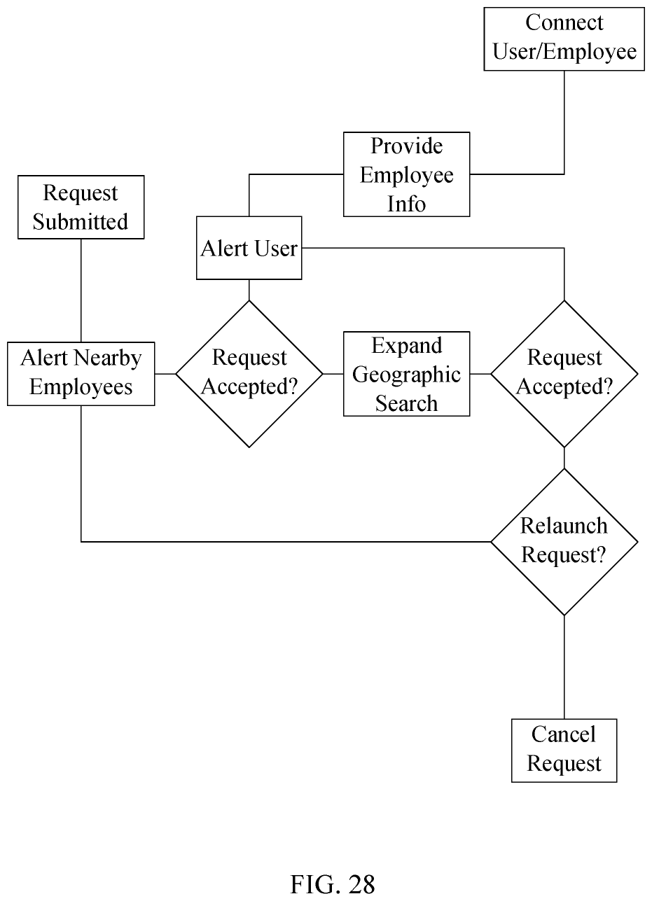

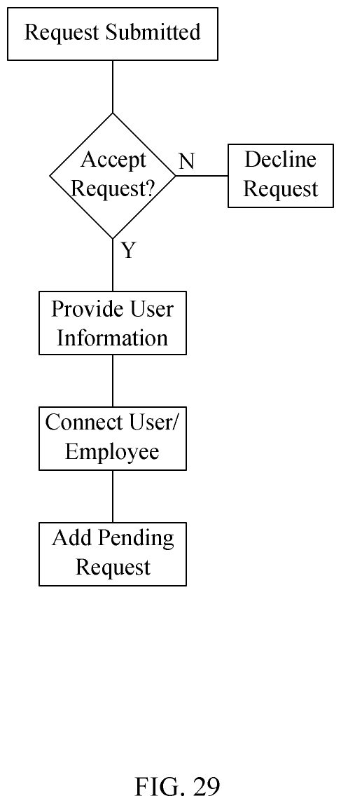

In the preferred embodiment of the present invention, after one or more service requests have been submitted, the system of the present invention will notify nearby employees regarding the one or more service requests submitted by one or more customers. As can be seen in FIG. 28, the system of the present invention alerts nearby employees regarding one or more service requests submitted around the employees location during a period. As can be seen in FIG. 28, if no nearby employees have accepted the one or more service requests during the period, the system of the present invention expands the geographical area within which more employees are offered the one or more service requests for another period. As can be seen in FIG. 29, employees are notified regarding new one or more service requests with one or more notifications sent through the software application of the present invention. As can be seen in FIG. 29, employees are given the option to accept and/or decline one or more service requests. However, if no employee has accepted the one or more service requests, the system of the present invention enables customers to relaunch the one or more service requests as many times the customer desires, otherwise the one or more requests are canceled. In the preferred embodiment of the present invention, if a plurality of employees has accepted the one or more requests at the same time, the system of the present invention will assign the one or more requests to the closest employee to the one or more service requests. In alternate embodiments of the present invention, the system of the present invention may utilize different methods to assign one or more requests when ties or other issues arise when accepting/declining one or more service requests.

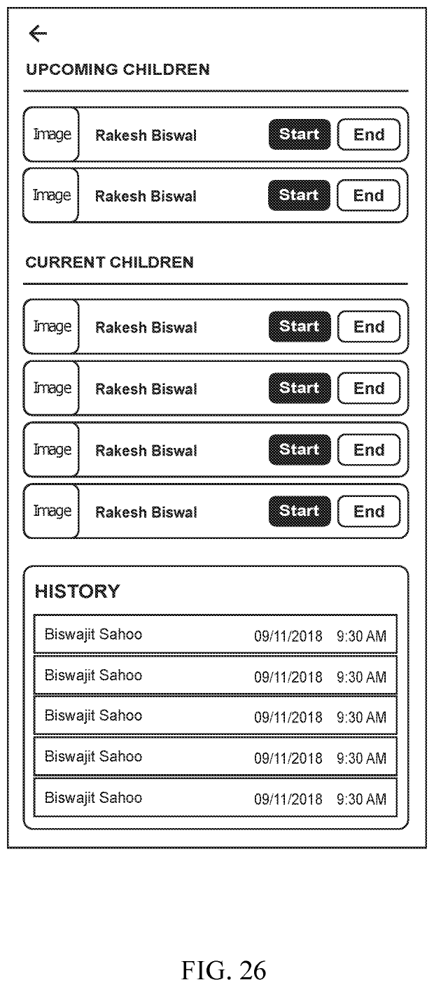

In the preferred embodiment of the present invention, once the one or more service requests have been accepted by one or more employees, both customers and employees are provided with contact information and other information. As can be seen in FIGS. 28 and 29, customers are provided with contact information as well as address information if the one or more service requests were to happen outside from the customers' homes. As can be seen in FIGS. 28 and 29, the one or more employees who have accepted one or more request receive a plurality of notifications with information regarding the one or more children and the one or more parents requesting childcare services. Likewise, customers are provided with information regarding the one or more employees providing the childcare services by linking the one or more employees' profiles. In the preferred embodiment of the present invention, the software application of the present invention provides users with one or more UIs showing the pending requests and/or request history. As can be seen in FIG. 26, the software application of the present invention enables customers to check the request history and further enables employees to check the upcoming childcare services. Furthermore, the software application of the present invention provides one or more UIs which enable employees to provide childcare services and customers to maintain communication with employees during childcare services. In the preferred embodiment of the present invention, the software application of the present invention provides customers with navigation directions as well as contact methods to reach the one or more employees providing the childcare services. Further, the software application of the present invention provides employees with one or more functions to perform a plurality of operations during child-care services. In the preferred embodiment of the present invention, the software application of the present invention provides a switch button which enables employees to change the employees' status. When online, employees are provided with one or more UIs which provide employees with information for the upcoming childcare services. When offline, the software application of the present invention provides employees with normal UIs which are also shown to customers. In further embodiments of the present invention, the software application of the present invention can be modified to provide additional tools for customers and employees to utilize during childcare services. In an embodiment of the present invention, the system of the present invention automatically notifies customers, parents/guardians when the one or more employees providing childcare services change location without the customers approval. The software application of the present invention utilizes a plurality of methods such as geofencing which can be provided by third-party services to track the location of the employees providing the childcare services or the one or more children being cared for. Further, the software application of the present invention can utilize activity recognition APIs to perform movement detection as part of a plurality of safety features.

In the preferred embodiment of the present invention, the system of the present invention tracks a plurality of variables during the childcare services. As can be seen in FIG. 18, the system of the present invention tracks the start time of the childcare service once the employee signals the childcare session starts. In the preferred embodiment of the present invention, the employees signal the start of one or more childcare services by clicking on the pending requests function on the software application of the present invention and selecting the customer corresponding to the childcare session being serviced. Once the childcare session starts, the software application of the present invention provides employees with the customer's name, date, time, communication methods to contact the customer, list of children being cared for, etc. One or more functions can further be provided on the software application for the employees to manually start the childcare session or to program the software application to star the childcare session at a predetermined time. In alternate embodiments of the present invention, the software application of the present invention may comprise additional tools for the employees to track different variables during the childcare session. After the childcare session is completed by the employee, the employee can terminate the childcare session on the software application of the present invention. The system of the present invention enables customers to rate the service experience, the employees' services, bookmark/favorite the employees, etc. Then, the system of the present invention credits the one or more employees who provided the childcare services through the payment services of the present invention.

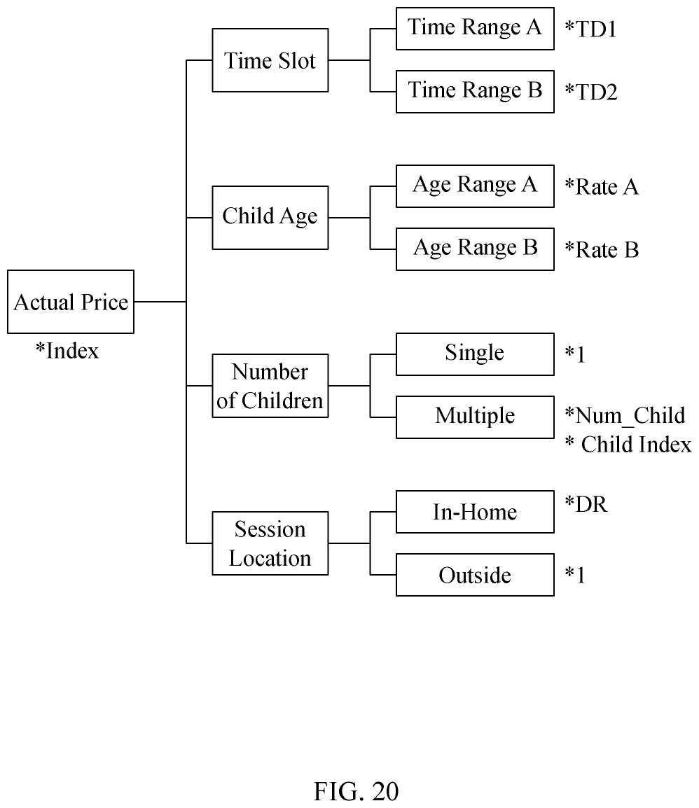

In the preferred embodiment of the present invention, the system of the present invention provides payment services. The plurality of payment services can include, but are not limited to, third-party payment services such as Stripe Connect, or can further provide in-house payment services. As can be seen in FIG. 22, the software application of the present invention enables users to input and/or store a plurality of payment information. Furthermore, the software application of the present invention enables employees to link payment methods for the employees to be paid for childcare services provided. In the preferred embodiment of the present invention, the system of the present invention bills the customers the amount of the total session price at the end of one or more services. The bill charge goes directly to the payment method provided by the customer. As can be seen in FIG. 20, the customer is billed at the end of each service based on a plurality of variables including, but not limited to, the number of hours, number of children, age of the children, time of the day, location, and/or other economic factors. In the preferred embodiment of the present invention, the system of the present invention can provide customers with an Estimated Price (EP) and an Actual Price (AP) for a service request. The plurality of prices can preferably be based on a plurality of formulas with a plurality of variables including, but not limited to, Rate A, Rate B, Index Econ, TD1, TD2, Child Index, Tax Percentage (Tax %), Margin Percentage (Margin %), and DR. Furthermore, the customer can incur extra fees for extending the childcare services longer than originally requested.

In the preferred embodiment of the present invention, Rate A and Rate B preferably correspond to base prices based on the children's age, with Rate A corresponding to children under age four and Rate B corresponding to children aged four and above. Index Econ comprises a value which preferably represents the economic level of a region. TD1 and TD2 comprise a value preferably corresponding to the time ranges on which a service request can be provided, with TD1 representing the time range between 6:30 AM and 7:30 PM, and TD2 representing the time range between 7:31 PM and 6:29 AM. Child Index comprises a value preferably used when there are more than one child in a service request. Tax % preferably corresponds to a percentage of the Net Price (NP) based on the formula:

NP=rate*Index Econ*TD Child Index*Hours*Number of Children

DR comprises a value preferably used if the customer chooses in-home services or outside services. Margin % comprises a percentage of total price retained by the system of the present invention based on the preferred formula:

Margin=Weekly Sales*Margin%

In the preferred embodiment of the present invention, the estimated price comprises an estimation for the purpose of giving customers with a price idea of the requested services and based on the preferred formula:

EP=Rate A*Index Econ*TD1

The actual price is preferably based on a plurality of formulas depending on the plurality of variables utilized by the system of the present invention. As can be seen in FIG. 20, the actual price is calculated utilizing the base Index Econ and multiplying the Index Econ by a plurality of variables depending on the nature of the service request. As can be seen in FIG. 20, the actual price preferably corresponds to the formula:

AP=Index Econ*Time Slot (TD1 or TD2)*Child Age (Rate A or Rate B)*Number of Children (1 or Num Child*Child Index)*Session Location (DR or 1)

Furthermore, the total price billed to the customer is based on the actual price plus the tax which depends on the region where the service request has been fulfilled. In addition, the payment system of the present invention comprises a system to compensate the employees for the childcare services provided. In the preferred embodiment of the present invention, the system of the present invention pays employees in a periodic basis based on the employees' periodic sales and on the preferred formula:

Employee Pay=Weekly Sales/Revenue−Margin Margin=Weekly Sales*Margin Percentage

In the preferred embodiment of the present invention, the margin percentage variable is an editable variable input and stored in the backend and is based on the percentage of the weekly sales. In alternate embodiments of the present invention, the plurality of variables utilized by the payment system of the present invention can be modified to accommodate different values to different variables corresponding to different aspects of child care services, such as different time slot ranges, different age ranges, etc.

Although the invention has been explained in relation to its preferred embodiment, it is to be understood that many other possible modifications and variations can be made without departing from the spirit and scope of the invention as hereinafter claimed.

1. A method of managing and scheduling childcare services, the method comprises the steps of:
(A)providing at least one client account managed by at least one remote server, wherein the at least one client account is associated with at least one client personal computing (PC) device;
(B) providing a plurality of provider accounts managed by the remote server, wherein each provider account includes a provider profile, and wherein each provider account is associated with a corresponding provider PC device;
(C) prompting the client account to generate a session request through the client PC device;
(D) relaying the session request from the client PC device to the remote server, if the session request is selected to be generated by the client account;
(E) assessing a plurality of best available accounts for the session request with the remote server, wherein the plurality of best available accounts is from the plurality of provider accounts;
(F) prompting each best available account to accept the session request through the corresponding provider PC device;
(G)relaying the provider profile of at least one arbitrary account from the remote server to the client PC device, if the session request is accepted by the arbitrary account, wherein the arbitrary account is any account from the plurality of best available accounts;
(H) prompting the client account to confirm the session request with the arbitrary account through the client PC device; and
(I) executing an administrative process for the session request between the client account and the arbitrary account through the remote server, if the session request is confirmed by the client account.

2. The method of managing and scheduling childcare services, the method as claimed in claim 1 comprises the steps of:
providing the client account with a plurality of registered child profiles, wherein the plurality of registered child profiles is managed by the remote server;
prompting the client account to enter a desired date-and-time, a desired location, and a required amount of service time for the session request with the client PC device;
prompting the client account to select at least one applicable child profile for the session request with the client PC device, wherein the applicable child profile is from the plurality of registered child profiles;
relaying the desired date-and-time, the desired location, the required amount of service time, and the applicable child profile from the client PC device to the remote server, if the desired date-and-time, the desired location, and the required amount of service time is entered by the client account, and if the applicable child profile is selected by the client account; and
appending the desired date-and-time, the desired location, the required amount of service time, and the applicable child profile into the session request with the remote server before step (E).

3. The method of managing and scheduling childcare services, the method as claimed in claim 2 comprises the steps of:
prompting the client account to enter a new child profile through the client PC device;
relaying the new child profile from the client PC device to the remote server, if the new child profile is entered by the client account; and
appending the new child profile into the plurality of registered child profiles with the remote server.

4. The method of managing and scheduling childcare services, the method as claimed in claim 1 comprises the steps of:
providing the client account with a location search radius, wherein the location search radius is centered around a desired location of the session request;
prompting each provider account to select between an online status or an offline status with the corresponding provider PC device;
relaying the online status or the offline status from the corresponding provider PC device of each provider account to the remote server;
tracking a current location of each provider account through the corresponding provider PC device; and
executing step (E), wherein the current location of each best available account is within the location search radius, and wherein each best available account is designated with the online status.

5. The method of managing and scheduling childcare services, the method as claimed in claim 4 comprises the steps of:
providing the client account with either a high favorability rating, an ambivalent favorability rating, or a low favorability rating for each provider account; and
further executing step (E), wherein each best available account is designated with the high favorability rating.

6. The method of managing and scheduling childcare services, the method as claimed in claim 1 comprises the steps of:
relaying a notification for the session request from the remote server to the corresponding provider PC device of each best available account; and
outputting the notification for the session request with the corresponding provider PC device of each best available account before step (F).

7. The method of managing and scheduling childcare services, the method as claimed in claim 1 comprises the steps of:
providing an expiration time period stored on the remote server;
prompting the client account to abandon, repeat, or modify the session request through the client PC device, if the expiration time period is lapsed after step (F);
cancelling the session request to each best available account with the remote server, if the session request is selected to be abandoned by the client account;
repeating steps (D) through (F) if the session request is selected to be repeated by the client account;
prompting the client account to enter at least one modification to the session request through the client PC device, if the session request is selected to be modified by the client account;
relaying the modification from the client PC device to the remote server, if the modification to the session request is entered by the client account; and
repeating steps (D) through (F) with the modification to the session request.

8. The method of managing and scheduling childcare services, the method as claimed in claim 1 comprises the steps of:
providing each provider account with an hourly rate;
providing the session request with a desired date-and-time, a desired location, a required amount of service time, and at least one applicable child profile;
calculating an initial session price for the session request based on the desired date-and-time, the desired location, the required amount of service time, and the applicable child profile with the remote server during step (C);
displaying the initial session price with the client PC device during step (C);
calculating a final session price for the session request based on the desired date-and-time, the desired location, the required amount of service time, the applicable child profile, and the hourly rate of the arbitrary account with the remote server during step (I); and
financially charging the final session price to the client account with the remote server during step (I).

9. The method of managing and scheduling childcare services, the method as claimed in claim 8, wherein the initial session price is proportionally based on a number of children indicated by the applicable child profile, and wherein the final session price is proportionally based on the number of children indicated by the applicable child profile.

10. The method of managing and scheduling childcare services, the method as claimed in claim 8, wherein a plurality of time ranges is stored by the remote server, and wherein each time range is designated with a busyness rating, and wherein the desired date-and-time is within a specific range from the plurality of time ranges, and wherein the initial session price is proportionally based on the busyness rating of the specific range, and wherein the final session price is proportionally based on the busyness rating of the specific range.

11. The method of managing and scheduling childcare services, the method as claimed in claim 8, wherein an in-house setting and an outside setting is stored by the remote server, and wherein the initial session price is higher, if the desired location is designated as the in-house setting instead of the outside setting, and wherein the final session price is higher, if the desired location is designated as the in-house setting instead of the outside setting.

12. The method of managing and scheduling childcare services, the method as claimed in claim 8, wherein a plurality of economically-defined regions is stored by the remote server, and wherein each economically-defined region is designated with an affluency rating, and wherein the desired location is within a specific region from the plurality of economically-defined regions, and wherein the initial session price is proportionally based on the affluency rating of the specific region, and wherein the final session price is proportionally based on the affluency rating of the specific region.

13. The method of managing and scheduling childcare services, the method as claimed in claim 8, wherein the hourly rate is higher, if an age indicated in the applicable child profile is lower than a young-child age threshold stored on the remote server, and wherein the hourly rate is lower, if the age indicated in the applicable child profile is higher than the young-child age threshold stored on the remote server.

14. The method of managing and scheduling childcare services, the method as claimed in claim 1 comprises the steps of:
providing the session request with a desired location;
tracking a current location of each provider account through the corresponding provider PC device;
relaying a change-of-location notification for the session request from the remote server to the client PC device, if the current location of the arbitrary account does not match the desired location, wherein the change-of location notification includes the current location of the arbitrary account; and
displaying the change-of-location notification with the client PC device during step (I).

15. The method of managing and scheduling childcare services, the method as claimed in claim 1 comprises the steps of:
prompting the arbitrary account to select another account from the plurality of best available accounts with the corresponding provider PC device;
relaying a selection of the other account from the corresponding provider PC device of the arbitrary account to the remote server; and
alternatively executing step (I) between the client account and the other account.

16. The method of managing and scheduling childcare services, the method as claimed in claim 1 comprises the steps of:
providing at least one administrative account managed by the remote server, wherein the administrative account is associated with at least one administrative PC device;
executing a plurality of iterations for steps (C) through (I), wherein transactional data for each iteration is collected by the remote server; and
enabling the administrative account to navigate through the transactional data for each iteration through the administrative PC device.
